(19) United States
(12) Patent Application Publication
(10) Pub. No.: US 2008/0177961 A1
(43) Pub. Date: Jul. 24, 2008

(54) Partial Backup and Restore with Backup Versioning

(75) Inventors: Jeffrey A. McSharry, Tucson, AZ (US); David C. Reed, Tucson, AZ (US); Max D. Smith, Tucson, AZ (US)

Correspondence Address: INGRASSIA FISHER & LORENZ, P.C. (IBM), 7010 E. COCHISE ROAD, SCOTTSDALE, AZ, 85253, US

(73) Assignee: INTERNATIONAL BUSINESS MACHINES CORPORATION, Armonk, NY (US)

(21) Appl. No.: 11/626,223

(22) Filed: Jan. 23, 2007

(51) Int. Cl. G06F 12/00

(52) U.S. Cl. 711/162; 711/E12.103

(57) ABSTRACT

A backup operation is performed on a source data set. The data set is segmented into a plurality of blocks. An update bit indicator is implemented for each of the plurality of blocks. The update bit indicator is appended to a field of an existing data index or tied to a mapping table having a relative byte address (RBA). The update bit indicator is set for each of the plurality of blocks which are newly created or changed from a first backup to a second backup, which generates a dump data set containing compressed blocks from the source data set. A backup operation is executed to backup each of the plurality of blocks having the update bit indicator set. The data index or mapping table is updated to show which of the plurality of blocks have changed from the first backup to the second backup.

### BACKGROUND OF THE INVENTION

1. Field of the Invention

The present invention relates in general to computers, and, more particularly, to a method of performing a backup operation in a storage system.

2. Description of the Prior Art

Data storage systems are used to store information provided by one or more host computer systems. Such data storage systems receive requests to write information to a plurality of data storage devices and requests to retrieve information from that plurality of data storage devices. It is known in the art to configure the plurality of data storage devices into two or more storage arrays.

Data storage devices and overall data storage systems traditionally use backup products which create redundant copies of the data for security, operational stability, and other factors. These backup products generally back up entire disks, volumes, and/or data sets. The backup products also generally restore entire disks, volumes, and/or data sets. These backup and restore operations can take a significant amount of time. In addition, significant system resources must be used, such as processor and storage space resources.

### SUMMARY OF THE INVENTION

In light of the foregoing, a need exists for a computer-implemented method which performs a backup operation on selected blocks or segments of data sets. The method should incorporate existing system resources and constraints, so as to provide an efficient, cost-effective and minimally invasive solution.

In one embodiment, the present invention is a computer-implemented method of performing a backup operation on a source data set, comprising segmenting the data set into a plurality of blocks, implementing an update bit indicator for each of the plurality of blocks, the update bit indicator appended to a field of an existing data index, wherein the update bit indicator is set for each of the plurality of blocks which are newly created or changed from a first backup to a second backup, generating a dump data set containing compressed blocks from the source data set, executing a backup operation to backup each of the plurality of blocks having the update bit indicator set, and updating the data index to show which of the plurality of blocks have changed from the first backup to the second backup.

In another embodiment, the present invention is a computer-implemented method of performing a backup operation on a source data set, comprising segmenting the data into a plurality of blocks, implementing an update bit indicator for each of the plurality of blocks, the update bit indicator tied to a mapping table having a relative byte address (RBA) to map the blocks of the data set, wherein the update bit indicator is set for each of the plurality of blocks which are newly created or changed from a first backup to a second backup, generating a dump data set containing compressed blocks from the source data set, executing a backup operation to backup each of the plurality of blocks having the update bit indicator set, and updating the mapping table to show which of the plurality of blocks have changed from the first backup to the second backup.

In another embodiment, the present invention is a computer program product comprising a computer usable medium having computer usable program code for performing a backup operation on a source data set, the computer program product including computer usable program code for segmenting the data into a plurality of blocks, computer usable program code for implementing an update bit indicator for each of the plurality of blocks, the update bit indicator tied to a mapping table having a relative byte address (RBA) to map the blocks of the data set or appended to a field of an existing data index, wherein the update bit indicator is set for each of the plurality of blocks which are newly created or changed from a first backup to a second backup, generating a dump data set containing compressed blocks from the source data set, computer usable program code for executing a backup operation to backup each of the plurality of blocks having the update bit indicator set, and computer usable program code for updating the mapping table or data index to show which of the plurality of blocks have changed from the first backup to the second backup.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an example computer system which can implement and execute aspects of the present invention;

FIG. 2 illustrates a first example method of implementing aspects of the present invention; and

FIG. 3 illustrates a second example method of implementing aspects of the present invention.

### DETAILED DESCRIPTION OF THE DRAWINGS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, punch card, flash memory, integrated circuits, or other digital processing apparatus memory device.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

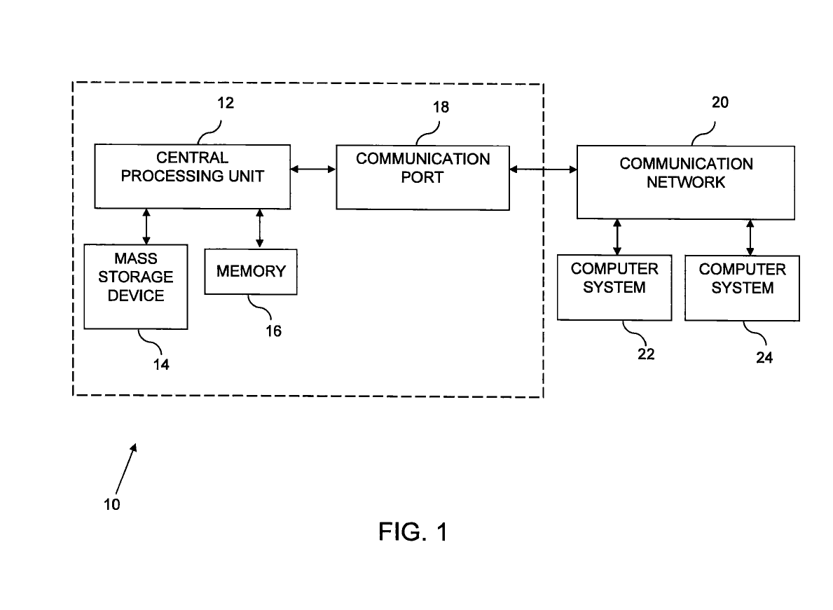

Turning to FIG. 1, an example computer system 10 is depicted which can implement various aspects of the present invention. Computer system 10 includes central processing unit (CPU) 12, which is connected to mass storage device(s) 14 and memory device 16. Mass storage devices can include hard disk drive (HDD) devices which can be configured in a redundant array of independent disks (RAID). The backup operations further described can be executed on device(s) 14, located in system 10 or elsewhere. Memory device 16 can include such memory as electrically erasable programmable read only memory (EEPROM) or a host of related devices. Memory device 16 and mass storage device 14 are connected to CPU 12 via a signal bearing medium. In addition, CPU 12 is connected through communication port 18 to a communication network 20, having an attached plurality of additional computer systems 22 and 24.

A method can be implemented according to the present invention for performing a partial backup and/or restore operation, which provides for automated backup versioning. A respective data set or file can be broken down into blocks. The blocks can be monitored for updates. Only the respective blocks which have changed since the last backup are backed up. The updated blocks can be written into the original backup file, so the original backup remains a complete backup of the file. Copies of this backup file can be kept so that versioning of the file will be automated.

Most data is written and stored in blocks. In one embodiment, virtual storage access method (VSAM) data sets are written and stored in blocks referred to “control intervals” (CI). Open data sets are generally written in 4 kbyte block segments. An update bit indicator for each of these blocks can be used to keep track of which blocks have changed since the last backup. In the case of a VSAM data set, an additional field can be appended to the existing index, since the index already maps all of the existing CIs for a respective data sets. In an additional embodiment with storage devices incorporating non-indexed data sets, a mapping table can be used with a relative byte address (RBA) to map the blocks of the data set.

When a new data set is created, or a data set that has never been backed up is introduced to the method, a back_up_required bit for each block can be set high, indicating that the respective data set would need a complete backup. As a result, a dump data set is created, which contains the compressed blocks from the source data set. The dump data set would contain the data from the source file, plus control information which would have the CI or RBA and a respective location from where the data was dumped.

Once the data has been completely backed up one time, each subsequent backup will only backup those blocks which have changed. When a backup utility runs against the data set, it will backup all blocks with the back_up_required bit set high. As the source data set is updated, the index or RBA table can be updated to show which blocks have changed. When the next backup job runs, only the changed blocks would be copied to the existing backup data set, overwriting the changed blocks.

Implementing the above method can cause the backup of the file to run significantly faster if only small portions of the file are changed over a given period of time. As is the case in many cases, only the end of many files are changed. Thus, the backup data set would only include those changed blocks updated. A user continues to have access to a complete backup of the single data set, even though iterations of partial backups have taken place. This is an advantage over other types of incremental backup methodologies which write each iteration to a separate file. Other methodologies can require multiple tape mounts during a typical restore operation.

After a backup operation has completed, a user can be given an option to copy the complete dump data set to keep multiple versions of their backup. At restore time, the user can restore the entire file, or the individual blocks which the user requires. For example, if the data set spans several volumes, and one of the volumes is destroyed or replaced, the user can restore the respective blocks for the destroyed or replaced volume. If a particular track went bad or was overwritten on the source data set, the user can restore just those blocks.

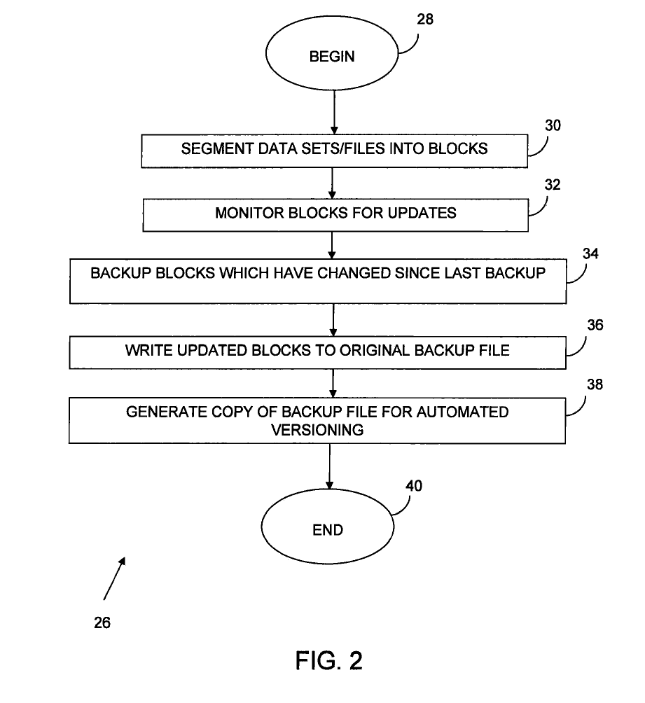

Turning to FIG. 2, an example method 26, which implements aspects of the present invention as previously described, is depicted. Method 26 begins (step 28) by segmenting a respective data set(s) or file(s) into respective blocks (step 30). The respective blocks are then monitored for updates (step 32). Blocks which have been determined by the computer system 10 to have changed since the last backup are backed up (step 34). The updated blocks are then written to the original backup file (step 36). Finally, a copy of the backup file can be generated to provide for automated versioning (step 38) in an optional operation. Method 26 then ends (step 40).

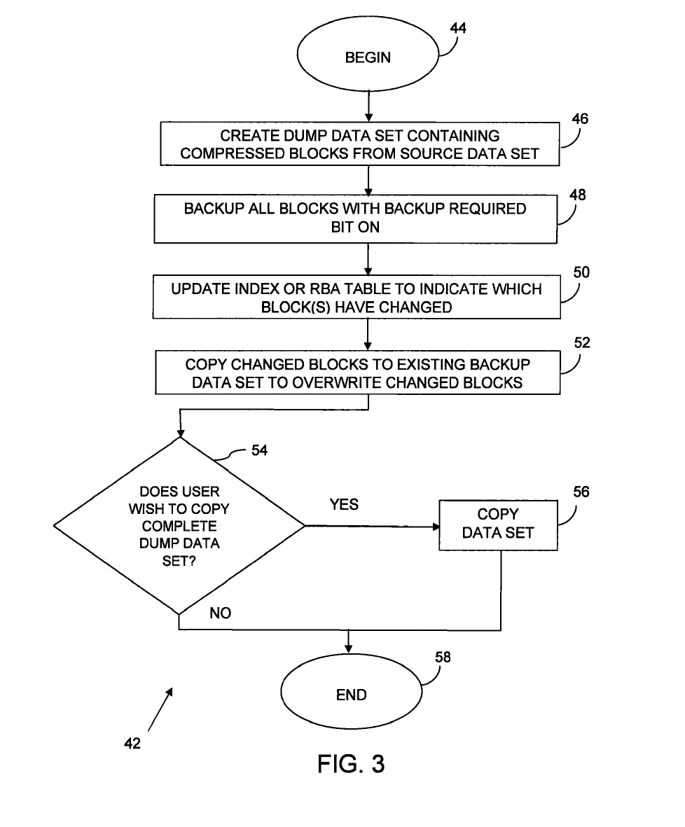

Turning to FIG. 3, a second example method 42, which implements various aspects of the present invention as previously described, is depicted. Method 42 begins (step 44) by the generation of a dump data set containing compressed blocks from a source data set (step 46). As has been described, an update bit indicator can be implemented for each of the respective blocks to keep track of which of the blocks have changed, which is appended as an additional field to an existing index or used in conjunction with a mapping table with an RBA. Those blocks having the back_up_required bit on, or set high, are backed up (step 48). Next, the index or RBA mapping table is updated to reflect which block(s) have been changed (step 50). Those changed blocks are copied to the existing backup data set to overwrite changed blocks (step 52). Only those changed blocks are affected, which saves execution time.

At the end of a backup operation or series of backup operations, a user can be presented with an option to copy the complete data set to keep versions of their backup (step 54). If desired, the data set is copied (step 56). Method 42 then ends (step 58). In similar fashion, a user can be presented with an option to restore the complete data set, or an option just to restore selected blocks from a respective data set in a restore operation.

Software and/or hardware to implement the methods 26 and 40 previously described, such as the described segmenting of data sets/files into blocks, can be created using tools currently known in the art. Implementation of the described computer system and method involves no significant additional expenditure of resources or additional hardware than what is already in use in standard computing environments, which makes the implementation cost-effective.

Implementing and utilizing the example methods as described can provide a simple, effective method of providing for partial backup and restore operations having backup versioning capability in computer systems described, and serves to maximize the performance of the computer system. While one or more embodiments of the present invention have been illustrated in detail, the skilled artisan will appreciate that modifications and adaptations to those embodiments may be made without departing from the scope of the present invention as set forth in the following claims.

What is claimed is:

1. A method of performing a backup operation on a source data set, comprising:
segmenting the data set into a plurality of blocks;
implementing an update bit indicator for each of the plurality of blocks, the update bit indicator appended to a field of an existing data index, wherein the update bit indicator is set for each of the plurality of blocks which are newly created or changed from a first backup to a second backup, generating a dump data set containing compressed blocks from the source data set;
executing a backup operation to backup each of the plurality of blocks having the update bit indicator set; and
updating the data index to show which of the plurality of blocks have changed from the first backup to the second backup.

2. The method of claim 1, further including completely copying the dump data set to provide for automated versioning.

3. The method of claim 1, further including copying a selected block of the plurality of blocks, the selected block specified by a user.

4. The method of claim 1, wherein the dump data set contains data from the source data set in addition to control and location information.

5. The method of claim 4, wherein the control information further includes a control interval (CI) or relative byte number.

6. The method of claim 4, wherein the location information further includes a location identifying where a first block of the plurality of blocks was dumped.

7. The method of claim 1, wherein the data set is compatible with a virtual storage access method (VSAM) disk file storage scheme.

8. A computer-implemented method of performing a backup operation on a source data set, comprising:
segmenting the data into a plurality of blocks;
implementing an update bit indicator for each of the plurality of blocks, the update bit indicator tied to a mapping table having a relative byte address (RBA) to map the blocks of the data set, wherein the update bit indicator is set for each of the plurality of blocks which are newly created or changed from a first backup to a second backup, generating a dump data set containing compressed blocks from the source data set;
executing a backup operation to backup each of the plurality of blocks having the update bit indicator set; and
updating the mapping table to show which of the plurality of blocks have changed from the first backup to the second backup.

9. The method of claim 8, further including completely copying the dump data set to provide for automated versioning.

10. The method of claim 1, further including copying a selected block of the plurality of blocks, the selected block specified by a user.

11. The method of claim 1, wherein the dump data set contains data from the source data set in addition to control and location information.

12. The method of claim 4, wherein the control information further includes a control interval (CI) or relative byte number.

13. The method of claim 4, wherein the location information further includes a location identifying where a first block of the plurality of blocks was dumped.

14. The method of claim 1, wherein the data set is compatible with a virtual storage access method (VSAM) disk file storage scheme.

15. A computer program product comprising:
a computer usable medium having computer usable program code for performing a backup operation on a source data set, the computer program product including;
computer usable program code for segmenting the data into a plurality of blocks;
computer usable program code for implementing an update bit indicator for each of the plurality of blocks, the update bit indicator tied to a mapping table having a relative byte address (RBA) to map the blocks of the data set or appended to a field of an existing data index, wherein the update bit indicator is set for each of the plurality of blocks which are newly created or changed from a first backup to a second backup, generating a dump data set containing compressed blocks from the source data set;
computer usable program code for executing a backup operation to backup each of the plurality of blocks having the update bit indicator set; and
computer usable program code for updating the mapping table or data index to show which of the plurality of blocks have changed from the first backup to the second backup.

16. The computer program product of claim 15, further including completely copying the dump data set to provide for automated versioning.

17. The computer program product of claim 15, further including copying a selected block of the plurality of blocks, the selected block specified by a user.

18. The computer program product of claim 15, wherein the dump data set contains data from the source data set in addition to control and location information.

19. The computer program product of claim 18, wherein the control information further includes a control interval (CI) or relative byte number.

20. The computer program product of claim 15, wherein the data set is compatible with a virtual storage access method (VSAM) disk file storage scheme.
